(19) United States
(12) Patent Application Publication
(10) Pub. No.: US 2014/0110149 A1
(43) Pub. Date: Apr. 24, 2014

(54) FLAME RETARDANT RESIN COMPOSITION AND INSULATED ELECTRICAL WIRE

(71) Applicant: Yazaki Corporation, Tokyo (JP)

(72) Inventor: Daisuke SUZUKI, Susono-shi (JP)

(73) Assignee: Yazaki Corporation, Tokyo (JP)

(21) Appl. No.: 14/146,423

(22) Filed: Jan. 2, 2014

Related U.S. Application Data
(63) Continuation-in-part of application No. PCT/JP2012/004085, filed on Jun. 25, 2012.

(30) Foreign Application Priority Data
Jul. 4, 2011 (JP) 2011-148484

(51) Int. Cl. H01B 3/42; H01B 7/295

(52) U.S. Cl. CPC H01B 3/427; H01B 7/295
USPC 174/110 SR; 524/145

(57) ABSTRACT

The objective of the invention is to provide flame retardant composition which is capable of providing thinner insulating covering or insulating layer for a vehicular insulated electrical wire, and meets abrasion resistance, gasoline resistance, flame retardant properties, and low temperature resistance requirements.

To attain the objective, there is provided a flame retardant composition, which contains 100 parts by weight of (A) base resin, containing (A1) from 40 to 70 parts by weight of polyphenylene ether, (A2) from 10 to 40 parts by weight of polyolefin, and (A3) from 10 to 30 of styrene ethylene butylene styrene block copolymer; and (B) from 10 to 30 parts by weight of condensed phosphoric acid ester.

### TECHNICAL FIELD

The invention relates to an insulated electrical wire showing remarkably enhanced abrasion resistance which may be particularly suited for vehicle application, and a flame-retardant composition used for the manufacture of an insulating covering of the insulated electrical wire. cl BACKGROUND ART

An insulated electrical wire disposed in a vehicle (i.e., a vehicular insulated electrical wire) is generally needed to meet high grade of abrasion resistance. This is because the vehicular insulated electrical wire is often disposed in vehicle interior in which a large amount of vibration occurs and there is only a little space.

In addition, the vehicular insulated electrical wire particularly disposed in an engine and so on is need to meet flame retardant properties, gasoline resistance, and low temperature resistance requirements. Furthermore, in order to facilitate or enhance cable routing and weight saving, the insulating covering of the insulated electrical wire is needed to be made thinner

In JP H11-147980 (A), there has been proposed a flame retardant resin composition, which contains y677 polypropylene-based resin as a matrix, polyphenylene ether-based resin as a dispersing agent, and hydrogenated block copolymer as an admixture.

However, in accordance with the conventional technologies, the content of polypropylene is relatively high, and the composition of hydrogenated block copolymer is not specified. Accordingly, in a case where the insulating layer of the insulated electrical wire is made thinner so as to facilitate or enhance cable routing and weight saving, it would not give satisfactory scrap abrasion resistance, and cannot meet other appropriate properties for an insulated electrical wire, such as gasoline resistance, flame retardant properties, and low temperature resistance outlined in the standard ISO (International Organization for Standardization) 6722.

### CITATION LIST

### Patent Literature

[PTL 1]

JP H11-147980 (A)

### SUMMARY OF INVENTION

### Technical Problem

In order to overcome the afore-mentioned drawbacks and problems, the invention is proposed. In other words, the objective of the invention is to provide flame retardant composition which is capable of providing thinner insulating covering or insulating layer for an insulated electrical wire suitable for a vehicle. At the same time, the flame retardant composition meets abrasion resistance, gasoline resistance, flame retardant properties, and low temperature resistance requirements.

### Solution to Problem

In one aspect, the present invention provides a flame retardant resin composition, which includes 100 parts by weight of (A) base resin, and (B) from 10 to 30 parts by weight of condensed phosphoric acid ester. The base resin (A) contains (A1) from 40 to 70 parts by weight of polyphenylene ether, (A2) from 10 to 40 parts by weight of polyolefin, and (A3) from 10 to 30 of styrene ethylene butylene styrene block copolymer.

Preferably, the styrene ethylene butylene styrene block copolymer (A3) can have styrene unit content of from 30% by weight to 65% by weight.

Preferably, the flame retardant composition can be used for the manufacture of an insulating covering of an insulated electrical wire.

In another aspect, the present invention provides an insulated electrical wire, which includes a conductor portion and an insulating covering disposed over the conductor portion. The insulating covering is formed of the flame retardant composition as indicated above.

### Advantageous Effects of Invention

When the flame retardant resin composition is used for the manufacture of an insulating layer for an insulated electrical wire, the resulting insulated electrical wire enables reduction in its thickness (i.e. the thickness of the insulating layer), and simultaneously meets all of abrasion resistance, gasoline resistance, flame retardant properties, and low temperature resistance requirements. Accordingly, the resulting insulated electrical wire would be optimally suitable for a vehicular application. wire.

However, the insulated electrical wire in accordance with the invention can be also used in a wide variety of fields or applications other than the vehicular insulated electrical wire.

### BRIEF DESCRIPTION OF DRAWINGS

FIG. 1 is a cross-section of an insulated electrical wire of the invention.

### DESCRIPTION OF EMBODIMENTS

As indicated above, the flame retardant resin composition in accordance with the invention contains (A) 100 parts by weight of a base resin, and (B) 10 to 30 parts by weight of condensed phosphoric acid ester. The base resin (100 parts by weight) contains (A1) 40 to 70 parts by weight of polyphenylene ether, (A2) 10 to 40 parts by weight of polyolefin, and (A3) 10 to 30 parts by weight of styrene ethylene butylene styrene block copolymer.

The polyphenylene ether (PPE) which can be employed in the invention can be obtained from, for example, Mitsubishi Engineering-Plastics Corporation. The polyphenylene ether can be present in an amount of from 40 parts by weight to 70 parts by weight in 100 parts by weight of the base resin. In a case where the polyphenylene ether is present in an amount of less than 40 parts by weight in 100 parts by weight of the base resin, desired abrasion resistance would be hardly achieved. On the other hand, in a case where the polyphenylene ether is present in an amount of greater than 70 parts by weight in 100 parts by weight of the base resin, gasoline resistance may be adversely affected.

The polyolefin (PO) which can be employed in the invention can be present in an amount of from 10 parts by weight to 40 parts by weight in 100 parts by weight of the base resin. In a case where polyolefin is present in an amount of less than 10 parts by weight in 100 parts by weight of the base resin, gasoline resistance would be adversely affected. On the other hand, in a case where polyolefin is present in an amount of greater than 40 parts by weight in 100 parts by weight of the base resin, flame retardant properties would be adversely affected.

The polyolefin which can be employed in the invention may include, but is not limited to, polymer or copolymer of ethylene, propylene, 1-butene, 1-pentene, 1-hexene, 3-methyl-1-butene, 4-methyl-1-pentene, 1-octene, 1-decene, 1-dodecene, 1-tetradecene, 1-hexadecene, 1-octadecene, 1-eicosene, or vinyl acetate; alpha-olefin polymer or copolymer; or any combination thereof. In accordance with one embodiment of the invention, due to excellent abrasion resistance polypropylene may be preferably used.

In accordance with one embodiment of the invention, the styrene ethylene butylene styrene block copolymer (SEBS) can be employed such that the content of styrene unit(s) is from 30% by weight to 65% by weight. In a case where the content of the styrene unit is less than 30% by weight, abrasion resistance may be adversely affected. On the other hand, in a case where the content of the styrene unit is greater than 65% by weight, gasoline resistance would be adversely affected. The styrene ethylene butylene styrene block copolymer which can be employed in one embodiment of the invention can be obtained from, for example, Asahi Kasei CHEMICALS CORPORATION.

In accordance with one embodiment of the invention, the styrene ethylene butylene styrene block copolymer can be present in an amount of from 10 parts by weight to 30 parts by weight in 100 parts by weight of the base resin. In a case where the styrene ethylene butylene styrene block copolymer is present in an amount of less than 10 parts by weight in 100 parts by weight of the base resin, low temperature resistance would be adversely affected. On the other hand, in a case where the styrene ethylene butylene styrene block copolymer is present in an amount of greater than 30 parts by weight in 100 parts by weight of the base resin, gasoline resistance, abrasion resistance and flame retardant properties would be adversely affected.

In addition to the above components, the flame retardant resin composition in accordance with the invention may further contain other frame retardants, flame retarding aids, antioxidants, metal deactivators, anti-aging agents, lubricants, fillers, reinforcing materials, ultraviolet absorbing agents, stabilizers, plasticizers, pigments, dyes, coloring agents, antistatic agents, foaming agents, other resins, other polymers or high molecules, additives and so on, or a combination thereof which does not adversely affect the intrinsic effect of the invention.

The other polymers or high molecules may include, but is not limited to, olefin resin, thermoplastic elastomer, rubber, and so on.

The frame retardant resin composition in accordance with one embodiment of the invention may be prepared by kneading the afore-mentioned components at a desired temperature by use of, for example, a twin screw extruder. The insulated electrical wire in accordance with one embodiment of the invention may be manufactured by optionally pelletizing the flame retardant resin composition, and shaping or forming an insulating layer or insulating covering over an inner core portion (i.e., a conductor portion) by using an extruder.

In accordance with one embodiment of the invention, a thin vehicular electrical wire, which has reduced weight and facilitates cable routing, may have an inner core portion (i.e., a conductor portion) which is formed of seven stranded wire elements and has a cross sectional area of 0.13 mm², and an insulating layer or insulating covering which is disposed over the inner core portion and has a thickness of at most 0.2 mm

The singular forms “a,” “an,” and “the” as used herein include plural referents unless the context clearly dictates otherwise. The present invention is further illustrated by the following non-limiting examples. A variety of flame retardant compositions, Examples # 1-5, and Comparative examples # 1-10 were prepared by mixing or blending the materials or components as listed in Table 1 in their amount as indicated in Tables 1 and 2, and subsequently kneading the mixture or blend by using a twin screw extruder. In this situation, the amount (i.e., content) is represented by parts by weight, unless the context clearly dictates otherwise.

TABLE 1

| Abbreviation | Material | Manufacturer, product name |
|---|---|---|
| PPE | polyphenylene ether | Mitsubishi Engineering- |
| | | Plastics Corporation, PX-100F |
| PO | polyolefin (high rigidity | SunAllomer Ltd., PS201A |
| | polypropylene) | |
| SEBS1 | styrene ethylene butylene | Asahi Kasei CHEMICALS |
| | styrene block copolymer | CORPORATION, H1043 |
| | (styrene unit: 67 wt %) | |
| SEBS2 | styrene ethylene butylene | Asahi Kasei CHEMICALS |
| | styrene block copolymer | CORPORATION, H1051 |
| | (styrene unit: 42 wt %) | |
| SEBS3 | styrene ethylene butylene | Asahi Kasei CHEMICALS |
| | styrene block copolymer | CORPORATION, H1053 |
| | (styrene unit: 29 wt %) | |
| PAE | condensed phosphoric acid | ADEKA |
| | ester (flame retardant) | CORPORATION, FP-600 |

Preparation of an Insulated Electrical Wire

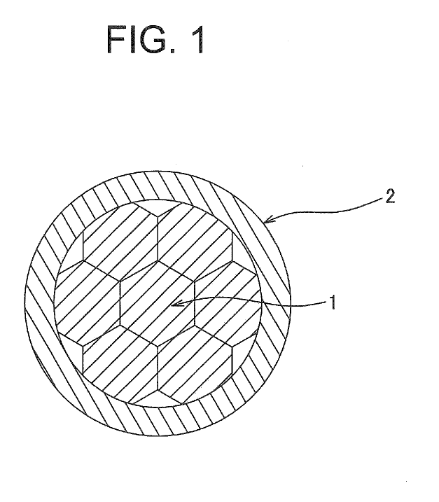

By using the afore-mentioned flame retardant resin compositions, insulated electrical wires were prepared respectively. In other words, the flame retardant resin compositions were subjected to extrusion molding at a temperature of 250 degrees Celsius such that the insulating layer or insulating covering having a thickness of 0.2 mm could be obtained. Each insulated electrical wire had an inner core portion (i.e., a conductor portion) which was formed of seven stranded wire elements, and had a cross sectional area of 0.13 mm². FIG. 1 shows a cross-section of an exemplary insulated electrical wire of the present invention. In FIG. 1, a reference numeral 1 represents a conductor portion, and a reference numeral 2 represents an insulating layer or insulating covering disposed over the conductor portion.

Furthermore, by using the flame retardant resin composition as described in Example 2, a plurality of electrical wires were prepared such that each of them had its insulating layer having a thickness selected from the group consisting of 0.2 mm, 0.1 mm, and 0.09 mm, and its conductor portion having a cross sectional area selected from the group consisting of 0.04 mm², 0.05 mm², and 0.13 mm² In any of the electrical wires, the conductor portion was formed of seven stranded wire elements. For more detail, see Tables 2 to 5.

TABLE 2

| | Example (#) | | | | | | |
|---|---|---|---|---|---|---|---|
| | 1 | 2 | 3 | 4 | 5 | 6 | 7 |
| PPE | 40 | 70 | 60 | 40 | 40 | 40 | 70 |
| PO | 40 | 20 | 10 | 40 | 40 | 40 | 20 |
| SEBS1 | 0 | 0 | 0 | 0 | 0 | 20 | 0 |
| SEBS2 | 20 | 10 | 30 | 20 | 20 | 0 | 0 |
| SEBS3 | 0 | 0 | 0 | 0 | 0 | 0 | 10 |
| PAE | 20 | 20 | 20 | 10 | 30 | 20 | 20 |
| Thickness of | 0.2 | 0.2 | 0.2 | 0.2 | 0.2 | 0.2 | 0.2 |
| insulating layer | | | | | | | |
| (mm) | | | | | | | |
| Cross sectional | 0.13 | 0.13 | 0.13 | 0.13 | 0.13 | 0.13 | 0.13 |
| area of conductor | | | | | | | |
| (mm²) | | | | | | | |
| Abrasion | ⊚ | ⊚ | ⊚ | ⊚ | ⊚ | ⊚ | ◯ |
| resistance | | | | | | | |
| Gasoline | ⊚ | ⊚ | ⊚ | ⊚ | ⊚ | ◯ | ⊚ |
| resistance | | | | | | | |
| Low temperature | ⊚ | ⊚ | ⊚ | ⊚ | ⊚ | ◯ | ⊚ |
| resistance | | | | | | | |
| Flame retardant | ⊚ | ⊚ | ⊚ | ⊚ | ⊚ | ⊚ | ⊚ |
| properties | | | | | | | |

TABLE 3

| | Comparative example (#) | | | | | | | | | |
|---|---|---|---|---|---|---|---|---|---|---|
| | 1 | 2 | 3 | 4 | 5 | 6 | 7 | 8 | 9 | 10 |
| PPE | 35 | 75 | 65 | 40 | 60 | 45 | 45 | 40 | 40 | 40 |
| PO | 35 | 15 | 5 | 45 | 35 | 20 | 40 | 45 | 40 | 40 |
| SEB1 | 0 | 0 | 0 | 0 | 0 | 0 | 0 | 0 | 20 | 0 |
| SEB2 | 30 | 10 | 30 | 15 | 5 | 35 | 15 | 15 | 0 | 0 |
| SEB3 | 0 | ◯ | 0 | 0 | 0 | 0 | 0 | 0 | 0 | 20 |
| PAE | 20 | 20 | 20 | 20 | 20 | 20 | 5 | 35 | 20 | 20 |
| Thickness of | 0.2 | 0.2 | 0.2 | 0.2 | 0.2 | 0.2 | 0.2 | 0.2 | 0.2 | 0.2 |
| insulating | | | | | | | | | | |
| layer (mm) | | | | | | | | | | |
| Cross sectional | 0.13 | 0.13 | 0.13 | 0.13 | 0.13 | 0.13 | 0.13 | 0.13 | 0.13 | 0.13 |
| area of | | | | | | | | | | |
| conductor (mm²) | | | | | | | | | | |
| Abrasion | x | ⊚ | ⊚ | x | ⊚ | x | Δ | ⊚ | ⊚ | x |
| resistance | | | | | | | | | | |
| Gasoline | ⊚ | x | x | ⊚ | ⊚ | X | ⊚ | Δ | X | ◯ |
| resistance | | | | | | | | | | |
| Low temperature | Δ | ◯ | ⊚ | ◯ | x | ⊚ | ◯ | x | Δ | ◯ |
| resistance | | | | | | | | | | |
| Flame retardant | x | ⊚ | ⊚ | Δ | ◯ | x | x | ⊚ | ◯ | ◯ |
| properties | | | | | | | | | | |

TABLE 4

Example (#)

| | 8 | 9 | 10 |
|---|---|---|---|
| PPE | 70 | 70 | 70 |
| PO | 20 | 20 | 20 |
| SEB2 | 10 | 10 | 10 |
| PAE | 20 | 20 | 20 |
| Thickness of insulating layer (mm) | 0.1 | 0.2 | 0.09 |
| Cross sectional are of conductor (mm²) | 0.13 | 0.13 | 0.13 |
| Abrasion resistance | ◯ | ⊚ | Δ |
| Gasoline resistance | ⊚ | ⊚ | ⊚ |
| Low temperature resistance | ◯ | ◯ | ◯ |
| Flame retardant properties | ⊚ | ⊚ | ⊚ |

TABLE 5

Example (#)

| | 11 | 12 | 13 |
|---|---|---|---|
| PPE | 70 | 70 | 70 |
| PO | 20 | 20 | 20 |
| SEBS2 | 10 | 10 | 10 |
| PAE | 20 | 20 | 20 |
| thickness of the insulating layer(mm) | 0.2 | 0.2 | 0.2 |
| Cross sectional area of conductor (mm²) | 0.05 | 0.13 | 0.04 |
| Abrasion resistance | ◯ | ⊚ | Δ |
| Gasoline resistance | ⊚ | ⊚ | ⊚ |
| Low temperature resistance | ◯ | ◯ | ◯ |
| Flame retardant properties | ⊚ | ⊚ | ⊚ |

Evaluation of the Insulated Electrical Wire

The resultant insulated electrical wires were evaluated in term of abrasion resistance, gasoline resistance, low-temperature performance (i.e., low temperature resistance), and flame retardant properties.

Abrasion Resistance Test

Following the procedures outlined in the standard ISO 6722, scrap abrasion resistance using 7N load and 0.45 millimeter needle was used on the resulting insulated electrical wires. The standard for evaluation is as follows: If the number of scrap is at least 200 times and any conduction between the conductor and the needle does not occur, the corresponding insulated electrical wire is recorded as “excellent”; if the number of scrap is at least 100 times and any conduction between the conductor and the needle does not occur, the corresponding insulated electrical wire is recorded as “good”; and if the number of scrap is less than 100 and the conduction between the conductor and the needle occurs, the corresponding insulated electrical wire is recorded as “poor”. For reference, the grades, “excellent” and “good” mean enough abrasion resistance, and the grade “poor” means insufficient abrasion resistance.

Gasoline Resistance Test

The resulting insulated electrical wires were immersed in gasoline at a temperature of 23 degrees Celsius for 20 hours, were dried for 30 minutes at an ambient air, and were wounded around a mandrel having a diameter five times greater than the outer diameter of the insulated electrical wire to be tested. The test procedure was performed in accordance with the standard ISO 6722. Each of the electrical wires was subjected to voltage of 1 kV for 1 minute. The results were evaluated as follows: if the electrical wire further withstands a voltage of at least 2 kV, it is recorded as “excellent”; if the insulated electrical wire withstands a voltage of 1 kV for one minute, it is recorded as “good”; and if the insulated electrical wire cannot withstand a voltage of 1 kV (i.e., a breakdown occurs), it is recorded as “poor”.

Low Temperature Resistance Test

In temperature-controlled room at a temperature of −40 degrees Celsius, a test outlined in the standard ISO 6722 was carried out for the resulting insulated electrical wires. Each of the insulated electrical wires was subjected to voltage of 1 kV for 1 minute. The results were evaluated as follows: if the insulated electrical wire, which is wound around a mandrel having a diameter of less than five times the outer diameter of the insulated electrical wire to be tested, withstands a voltage of 1 kV for one minute, it is recorded as “excellent”; if the insulated electrical wire, which is wound around a mandrel having a diameter of greater than five times the outer diameter of the insulated electrical wire to be tested, withstands a voltage of 1 kV for one minute, it is recorded as “good”; and if the insulated electrical wire cannot withstand a voltage of 1 kV for one minute (i.e., a breakdown occurs), it is recorded as “poor”.

Flame Retardant Properties Test

Each of the insulated electrical wires was disposed in a draft chamber such that it was laid tilted at 45 degrees angle with respect to a horizontal line. The insulated electrical wire was disposed in the inner flame of Bunsen burner for 5 seconds in accordance with the standard ISO 6722. After removing the Bunsen burner from the insulated electrical wire, the insulated electrical wires were evaluated for flame retardant properties, as follows: if flame-out time is within 30 seconds and at least 500 mm of the insulator (in particular, the upper portion of the insulator) remains without being burned, the corresponding insulated electrical wire is recorded as “excellent”; if flame-out time is within 70 seconds and at least 50 mm of the insulator remains without being burned, the corresponding insulated electrical wire is recorded as “good”; and if flame-out time is at least 70 seconds or less than 50 mm of the insulator remains without being burned, the corresponding insulated electrical wire is recorded as “poor”.

The above tests were repeated five times per one insulted electrical wire. The standard for evaluation is as follows: if all of the evaluations are “excellent”, “\textcircled{O}” is recorded which means enough performance; if the evaluations were “excellent” or “good”, “o” is recorded; if there is one to four “poor”, “Δ” is recorded which means insufficient performance; and if all of the evaluations are “poor”, “x” is recorded which means insufficient performance. The results of these evaluations are summarized in Tables 2 to 5 listed above.

The above test results shows that the insulted electrical wire having the conductor portion having a cross sectional area of at least 0.05 mm² and the insulating layer or insulating covering formed of the flame retardant resin composition in accordance with the invention and having a thickness of at least 0 1 mm gives satisfactory abrasion resistance, gasoline resistance, flame retardant properties, and low temperature resistance, and simultaneously gives an insulated electrical wire having relatively thin insulating layer or insulating covering.

While a preferred embodiment of the invention has been shown and described with particularity, it will be appreciated that various changes and modifications may suggest themselves to one having ordinary skill in the art upon being apprised of the present invention. It is also intended to encompass all such changes and modifications as fall within the scope and spirit of the appended claims.

### REFERENCE SIGNS LIST

1 conductor (i.e., an inner core)

2 insulating layer (i.e., an insulating covering)

1. A flame retardant composition, comprising: 100 parts by weight of (A) base resin, containing (A1) from 40 to 70 parts by weight of polyphenylene ether, (A2) from 10 to 40 parts by weight of polyolefin, and (A3) from 10 to 30 of styrene ethylene butylene styrene block copolymer; and (B) from 10 to 30 parts by weight of condensed phosphoric acid ester.

2. The flame retardant composition according to claim 1, wherein (B) styrene ethylene butylene styrene block copolymer has styrene unit content of from 30% by weight to 65% by weight.

3. The flame retardant composition according to claim 1, wherein the flame retardant composition is used for manufacture of an insulating covering of an insulated electrical wire.

4. An insulated electrical wire, comprising a conductor portion and an insulating covering disposed over the conductor portion, wherein the insulating covering is formed of the flame retardant composition according to claim 1.
